(19) United States
(12) Patent Application Publication
(10) Pub. No.: US 2017/0313571 A1
(43) Pub. Date: Nov. 2, 2017

(54) FUEL TRANSFER PUMP WITH WIRELESS CONTROL

(71) Applicant: Ahern IT LLC, Las Vegas, NV (US)

(72) Inventors: Leo Zamora, Las Vegas, NV (US); Jesse L. Zamora, Las Vegas, NV (US); Richard Ethington, Las Vegas, NV (US); Frank Taddeo, Las Vegas, NV (US); Jason Tezanos, Las Vegas, NV (US); Justin Stephens, Las Vegas, NV (US)

(73) Assignee: Ahern IT LLC

(21) Appl. No.: 15/582,325

(22) Filed: Apr. 28, 2017

Related U.S. Application Data
(60) Provisional application No. 62/329,144, filed on Apr. 28, 2016.

(51) Int. Cl. B67D 7/14; G05D 7/06; B67D 7/62; B67D 7/04; B67D 7/22; B67D 7/16; H04L 29/06; B67D 7/84

(52) U.S. Cl. CPC B67D 7/145; H04L 63/08; G05D 7/0617; B67D 7/84; B67D 7/04; B67D 7/22; B67D 7/16; B67D 7/62

(57) ABSTRACT

A fuel transfer pump electrical circuit for controlling a fuel transfer pump comprises a controller with communications logic configured for establishing a wireless communications link with a mobile device and a switch for activating a motor in the pump. The switch is controllably linked to the controller. The controller is configured to turn the switch on and off based on instructions received via the wireless communications link, thereby controlling the fuel transfer pump to turn a flow of fuel on and off. A mobile device application for interacting with the fuel transfer pump is also described.

### BACKGROUND

Tracking the use of equipment in the field continues to pose challenges. Equipment owners need to permit access of equipment so that it is fully utilized, which increases benefits to end users and owners alike. At the same time, owners must control access to equipment to ensure only authorized users have access to prevent theft, tampering and other unauthorized activities, as well as to ensure safety of the surroundings. Further, equipment owners struggle with ensuring that even authorized users use the equipment correctly so that they enjoy a positive experience and the equipment's useful life and intervals between required service are maximized. Moreover, owners desire to have more tracking information regarding users' interactions with equipment. For example, in the case of fuel transfer pumps used to transfer fuel for vehicles, which are often located in remote areas, pump operators seek to have more control. Pump operators desire to permit authorized users to access transfer pumps at any time of day and without cumbersome procedures, yet maintain accurate records of each user interaction with a pump for purposes of security and accurate accounting, but conventional solutions are lacking.

### SUMMARY

Described below are implementations of a fuel transfer pump electrical circuit for controlling a fuel transfer pump that address the drawbacks of conventional approaches.

According to a first implementation, a fuel transfer pump electrical circuit for controlling a fuel transfer pump, comprises a controller and a switch. The controller has communications logic configured for establishing a wireless communications link with a mobile device. The switch is for activating a motor in the pump, and is controllably linked to the controller. The controller is configured to turn the switch on and off based on instructions received via the wireless communications link.

In one implementation, the fuel transfer pump electrical circuit may further comprise a flow meter control logic connectible to a flow meter associated with the fuel transfer pump. The flow meter control logic comprises communications logic configured for establishing a separate flow meter wireless communications link with the mobile device via which flow data from the flow meter can be transmitted to mobile device.

In one implementation, the fuel transfer pump electrical circuit may further comprise a flow meter electrical circuit connected to a flow meter for the fuel transfer pump. The flow meter electrical circuit may comprise a flow meter controller with communications logic configured for establishing a flow meter wireless communications link with the mobile device and a flow meter switch controllably linked to the flow meter controller and connectable to the flow meter.

In one implementation, the controller is configured to receive an output set characteristic communicated from the mobile device via the wireless communications link and in response to control the switch to turn the fuel transfer pump on and off.

In one implementation, the flow meter controller comprises a pulser input configured to receive pulse counts indicating operation of the flow meter and to transmit the pulse counts to the mobile device via the flow meter wireless communications link.

In another implementation, a control circuit for a fuel transfer pump and associated flow meter comprises a circuit board configured for installation in a recess of a housing. The circuit board comprises a fuel transfer pump controller with communications logic configured for establishing a wireless communications link with a mobile device and a fuel transfer pump switch for activating a motor in the pump, the switch being controllably linked to the fuel transfer pump controller, and a pulser input linked to the controller and configured to receive pulse counts indicating operation of a flow meter associated with the fuel transfer pump.

In one implementation, the fuel transfer pump comprises the housing for the circuit board. In another implementation, the housing comprises a separate housing configured to be coupled to the fuel transfer pump. In another implementation, the housing is an explosion proof housing.

In one implementation, the circuit comprises at least one of an accelerometer and an altimeter. In one implementation, the wireless communications link are established according to a Bluetooth low energy protocol.

In one implementation, the circuit board comprises a memory for storing fuel transfer pump operation data, and wherein the fuel transfer pump controller causes fuel transfer pump data for a most recent transaction to be uploaded to the mobile device for communication to a web service upon restoration of the wireless communications link following an interruption.

In one implementation, the circuit board comprises a memory for storing fuel transfer pump operation data, and wherein the fuel transfer pump controller causes fuel transfer pump data for at least one prior incomplete transaction to be uploaded to the mobile device for communication to a web service upon establishment of a new wireless communications link following the incomplete transaction.

According to another implementation, a software application for configuring a mobile device to control a fuel transfer pump system comprises instructions for establishing a wireless communications link between the mobile device and a circuit of the fuel transfer pump, instructions for establishing a wireless communications link between the mobile device and a web service and instructions for carrying out two-factor authentication of the mobile device through queries displayed to the user on the mobile device and communications of data to the web service to determine if the mobile device is authorized. If the mobile device is authorized, instructions for displaying fuel transfer pump operation commands on the mobile device, receiving user input via the mobile device corresponding to a selected command and communicating the command to the fuel transfer pump circuit are carried out.

In one implementation, the software application comprises instructions to cause transaction data from the fuel transfer pump to be communicated from the fuel transfer pump to the mobile device and from the mobile device to the web service. In one implementation, the instructions to cause data from the fuel transfer pump to be communicated to the mobile device are issued following completion of a fuel transfer pump pumping event. In one implementation, the instructions to cause data from the fuel transfer pump to be communicated to the mobile device are issued following resumption of a wireless communication link between the mobile device and the fuel transfer pump following an interruption.

In one implementation, the instructions to cause data from the fuel transfer pump to be communicated to the mobile device are issued following establishment of a new wireless communication link between a new mobile device and the fuel transfer pump following an incomplete transaction, and the data communicated comprises data for at least one prior incomplete transaction.

In one implementation, the software application comprises instructions for transmitting flow meter data received from the fuel transfer pump system to the web service. In one implementation, the software application comprises instructions for transmitting flow transfer pump data from the fuel transfer pump system to the web service.

In one implementation, the software application comprises instructions for querying a user for a selected location, receiving an input from the mobile device indicating a selected location and displaying fuel transfer pump locations corresponding to the selected location.

In one implementation, the software application comprises instructions for querying a user for a selected asset to be fueled, receiving an input from the mobile device indicating a selected asset and displaying asset information for the selected asset to the user.

The foregoing and other features and advantages of the invention will become more apparent from the following detailed description, which proceeds with reference to the accompanying figures.

### BRIEF DESCRIPTION OF THE DRAWINGS

FIG. 1 is a schematic block diagram of a fuel transfer pump system providing for remote control via a mobile device.

FIG. 2 is a representative drawing showing a fuel transfer pump and an associated fuel meter coupled to the fuel transfer pump.

FIGS. 3A, 3B and 3C are flow diagrams of a process for authorizing a mobile device user and carrying out fuel transfer pump operations.

FIG. 4 is a schematic network diagram showing the fuel transfer pump system connected to the mobile device, which is in turn connected to a web services host to enable synchronous web services.

FIG. 5 is a schematic block diagram of a fuel transfer pump system according to another implementation.

FIG. 6 is a drawing of a separate housing used in some implementations to house all or a part of a circuit.

FIGS. 7A and 7B are drawings of components of a separate housing according to another implementation.

FIGS. 8A and 8B are drawings showing the other sides of the components of the separate housing of FIGS. 7A and 7B.

### DETAILED DESCRIPTION

Described below are implementations of a circuit providing for remote control of equipment, e.g., a fuel transfer pump or other similar equipment, using a mobile device.

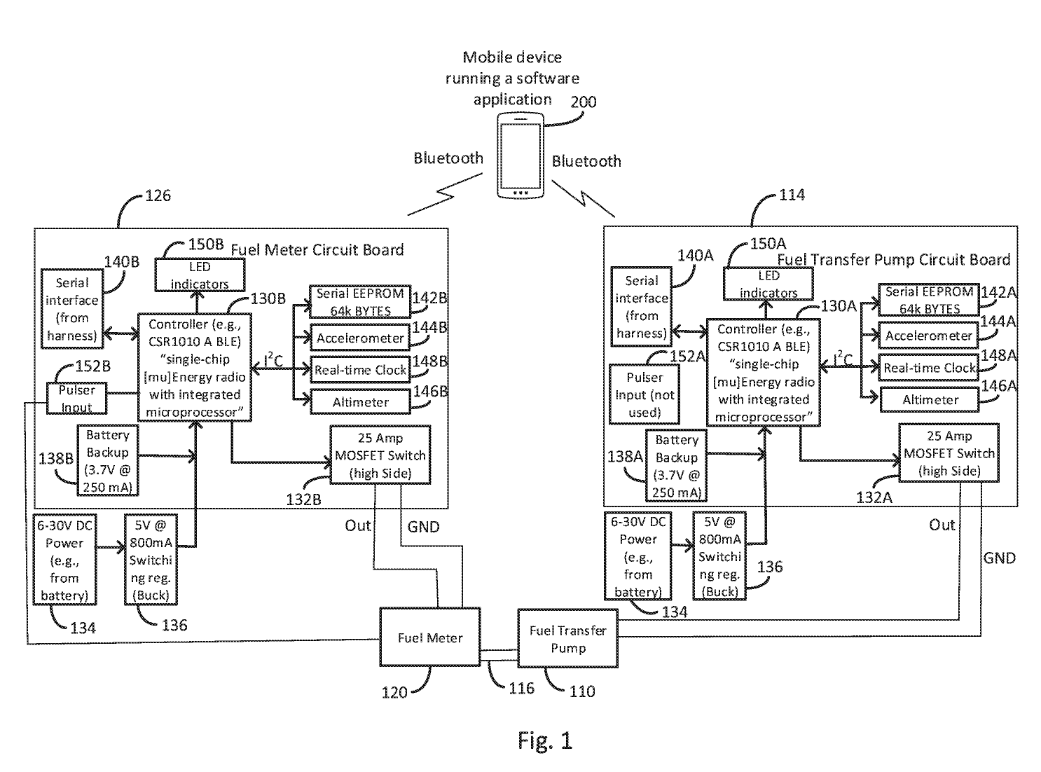

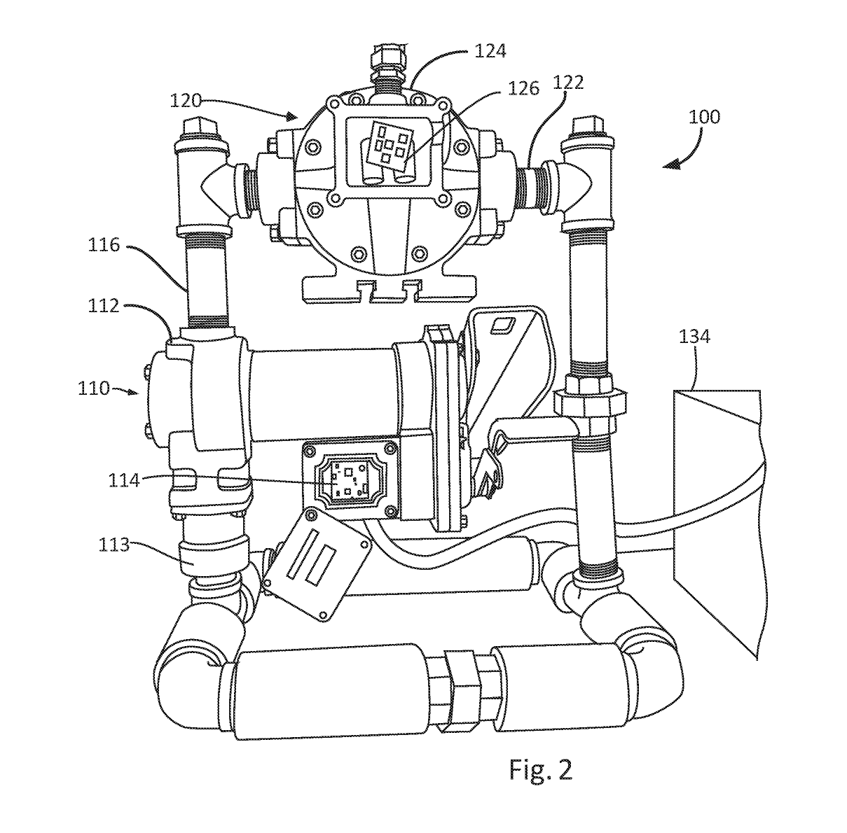

Referring to FIGS. 1 and 2, a fuel transfer pump system 100 includes a fuel transfer pump 110, a fuel meter 120 and a mobile device 200 (FIG. 1). The fuel transfer pump 100 can be a conventional fuel transfer pump suitable for transferring fuel (e.g., gasoline, diesel and other similar liquids), such as between a container and a vehicle. Such fuel transfer pumps can be installed at fixed locations, mounted to vehicles (such as to vehicle-mounted fuel supply tanks) or implemented as portable pumps. One suitable conventional fuel transfer pump is the Fill-Rite® 20 GPM (gallon per minute) high flow model, but fuel transfer pumps having higher or lower flow rates can also be used. In the illustrated implementation, the fuel transfer pump 110 is configured to be powered by DC power, such as 12-volt DC power, but pumps using other sources of power, including 24-volt DC and AC power, can also be used.

Referring to FIG. 2, the fuel transfer pump 110 has a body 112 with a pump inlet 113 and a pump outlet 116. The body 112 houses a motor and various other components of the pump (not shown). In the illustrated implementation, the fuel meter 120 is connected to the pump outlet 116 to receive a flow of fuel exiting the fuel transfer pump 110 and to measure its flow rate and/or volume. The fuel meter 120 is typically a conventional, high-accuracy mechanical flow meter with a body 124 that houses its internal components. Typically, a flexible hose with a lever-operated nozzle (not shown) is attached to a flow meter outlet 122. In use, provided the fuel transfer pump is in its operating mode as discussed below, the user activates the nozzle by squeezing a lever to cause fuel to flow into the tank and/or connector into which the nozzle is inserted. The nozzle may have a conventional hold-open lever or other similar device allowing the user to keep it in the activated position without requiring the user to continuously squeeze it.

As shown in FIG. 2, the fuel meter 120 has been fitted with a customized fuel meter circuit 126, which is housed in a recess of the body 124. Similarly, the fuel transfer pump 110 has been fitted with a customized fuel transfer pump circuit 114 housed in a recess of the body 112. (In another embodiment which is described below in detail, at least a part of a fuel transfer pump circuit is housed in a separate housing, which is typically attached to the fuel transfer pump's electrical input connection.) The fuel meter circuit 126 and the fuel transfer pump circuit 114 are explained in further detail with reference to the block diagram of FIG. 1. In the illustrated implementation, the fuel meter circuit 126 and the fuel transfer pump circuit are configured as circuit boards, but other topologies could of course be used.

FIG. 1 shows the fuel transfer pump circuit 114 and the fuel meter circuit 126 linked to a mobile device 200, such as a smart phone, a tablet computer, a laptop computer, a dedicated remote controller or another type of mobile device. As indicated, the mobile device 200 is linked to each of the fuel meter circuit 126 and the fuel transfer circuit 114 by a wireless connection. In one implementation, the wireless connections are Bluetooth connections. In some implementations, connections are established using the Bluetooth LE (low energy) standard, which, among other advantages, conserves battery power. Other Bluetooth standards, such as Bluetooth 5.0, can also be implemented. In addition to Bluetooth, it is of course possible to use other suitable wireless technologies to configure links between the mobile device 200 and the fuel meter circuit 126 and the fuel transfer pump circuit 114.

A variety of communications configurations can be configured between the fuel transfer pump circuit, the fuel meter circuit and the mobile device. For example, in one alternative implementation described in detail below, the mobile device 200 communicates directly with the fuel transfer circuit 114, which in turn communicates with the fuel meter circuit 126 using a second communications link, which could be a wireless or wired connection.

The fuel transfer pump circuit 114 comprises a controller 130A, which is connected to the motor of the fuel pump 110 via a switch or a transistor 132A, such as a 25-amp MOSFET transistor. The controller 130A receives power, such as 6-30 DC power, from a battery 134 (see also FIG. 2), which is converted to 5V DC at 800 mA (see block 136). Optionally, there can be a battery backup 138A to supply DC power, such as 3.7V at 250 mA. The controller 130A has a connection to a serial interface 140A. The serial interface 140A can provide for connecting a programming harness to the circuit to update or change functionality of its components, including the controller.

In the illustrated implementation, the controller is linked to a memory, one or more sensors and a clock. Specifically, the controller is 130A is linked to a memory 142A, such as a 64 kB EEPROM, two types of sensors (including an accelerometer 144A and an altimeter 146A) and a real-time clock 148A. The controller 130 can also be linked to an optional LED 150A, which can be configured to indicate a visual alert and/or operational status. The controller 130A can be configured to receive pulser input 152A, although such input is not used in the illustrated implementation of the fuel transfer pump circuit 114.

Although not required, in the illustrated implementation, the fuel meter circuit 126 is substantially identical to the fuel transfer pump circuit 114. Thus, the same components are referred to with like reference numerals, appended with the suffix B. In the illustrated implementation, the fuel meter circuit board 126 has a pulser input 152B from the fuel meter that is fed to the controller 130B.

As illustrated, the fuel transfer pump circuit 114 can include an optional accelerometer 144A and an optional altimeter 146A, and the fuel meter circuit 126 can likewise include an optional accelerometer 144B and altimeter 146B. In some implementations, the controller is programmed to receive signals from the accelerometer and/or altimeter, such as, e.g., to detect motion of an associated component or object. Such signals can be processed to determine if they meet predetermined criteria, and, if so, a determination can be made, e.g., that the component or object is in operation or is in motion. For example, if input from the accelerometer 144A meets a predetermined threshold, it can be determined that the fuel transfer pump is in operation. As another example, if input from the accelerometer 144B or the altimeter 146B has certain characteristics, it can be determined that tampering or theft may be occurring, and the system can be programmed to respond accordingly.

In the illustrated implementation, each of the fuel transfer pump circuit 114 and the fuel meter circuit 126 is configured in a small form factor, such as a small circuit board or other type of circuit component, such that it can directly replace the corresponding OEM circuit element within the same recess. The circuits 114, 126 can be designed to have substantial current switching capabilities, such as up to 30 amps. In one specific implementation, embodiments of the fuel transfer circuit 114 operate with a pump motor current of up to about 25 amps.

In the illustrated implementation, the controller 130A, 130B can be a single-chip micro energy radio with an integrated microprocessor. In the illustrated implementation, the connections between the memory 142A, 142B, the accelerometer 144A, 144B, the altimeter 146A, 146B and the clock 148A, 148B, to the controller 130A, 130B, respectively, can be optionally implemented using the I²C standard. Each controller (and/or one of its components) may comprise suitable circuitry, interfaces, logic and/or code, and can be used to coordinate activities and data flow.

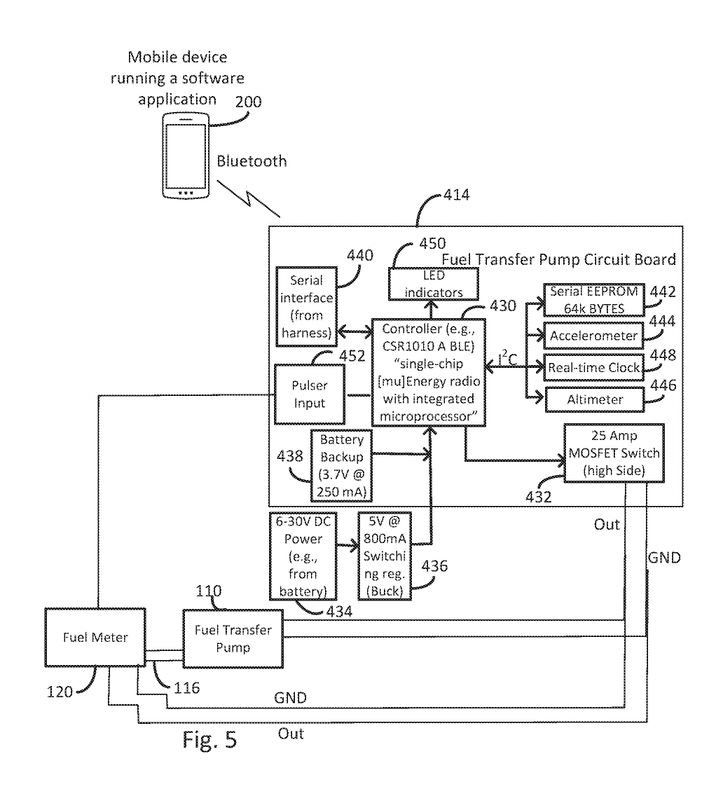

FIG. 5 is a schematic block diagram of a fuel transfer pump system similar to FIG. 1, but according to an alternative implementation in which control circuit functions are implemented using a single controller, such as in a fuel transfer pump circuit 414 as shown. Thus, the fuel meter circuit 126 and its separate controller 130B are not required. In FIG. 5, elements of the fuel transfer circuit 414 having the same function as in the circuit fuel transfer 114 are labelled with the same reference numeral plus 300 and are not further described except as follows.

As shown in FIG. 5, in the circuit 414, the fuel meter 120 is electrically connected to the same switch or a transistor 432 to which the fuel transfer pump 110 is connected. In this way, the fuel meter 120 is activated at the same time as the fuel transfer pump 110. The electrical connection between the switch or transistor 432 and the fuel meter 120 can be made with a short cable such that power is supplied to the fuel meter 120 as needed. The block 452 represents the pulser input 452, which in this case is connected to the fuel meter 120 as shown to receive a signal from the fuel meter corresponding to the fuel meter's activity.

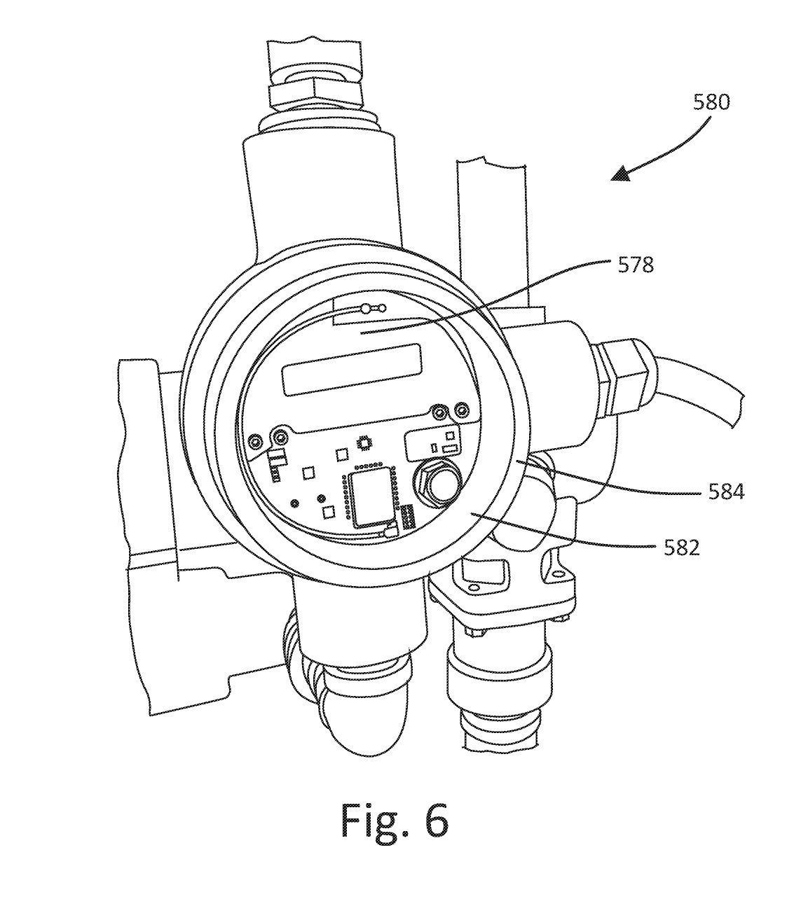

In some implementations, one or more portions of the circuits are positioned in a separate housing(s). For example, as shown in FIG. 6, there is a separate housing 580 (shown with its cover removed to reveal a recess 582 defined within a body 584), and a fuel transfer circuit 514 is implemented on a circuit board 578 that is positioned within the recess 582. In the illustrated implementation, the housing has three openings along its periphery: one for a power connection that supplies power to the fuel transfer circuit 514 (circuit board 578), one for the input to the pulser of the circuit from the fuel meter, and one that is threaded into the fuel transfer pump 110 and is connected to the electrical input connection.

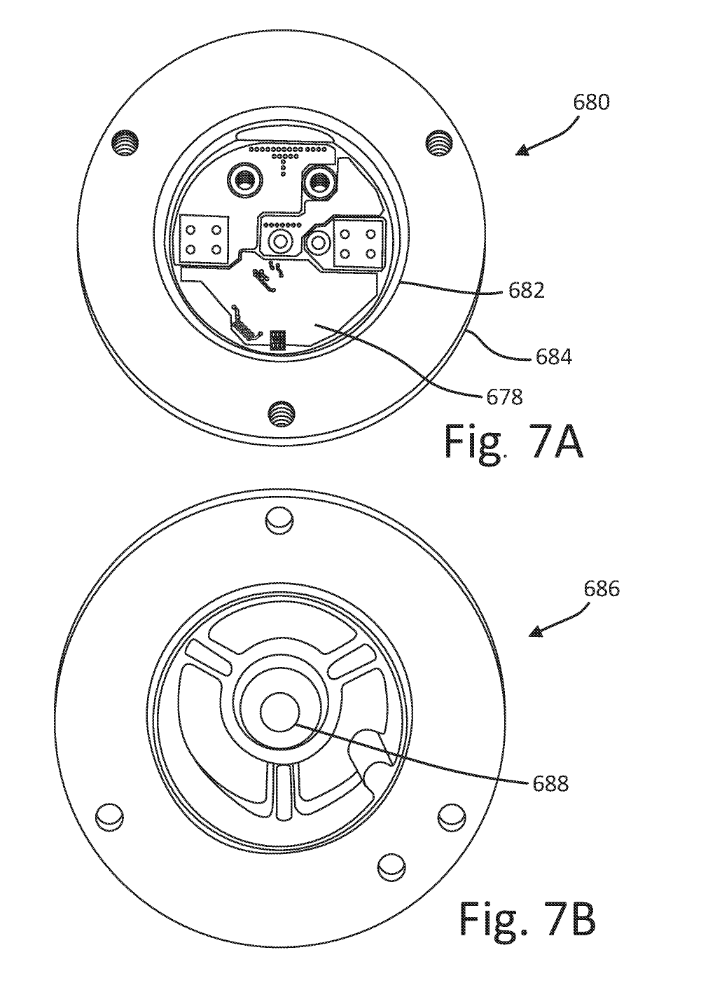

FIG. 7A is an elevation view of a housing 680 according to another implementation. In the housing 680, there is a recess 682 defined within a body 684, and a fuel transfer circuit 614 is implemented on a circuit board 678 that is positioned within the recess 682. A cover 686 shaped to cover the housing 680 is shown in FIG. 7B. The cover 686 can have an opening 688 through which conductors can be routed to and from the circuit board 678.

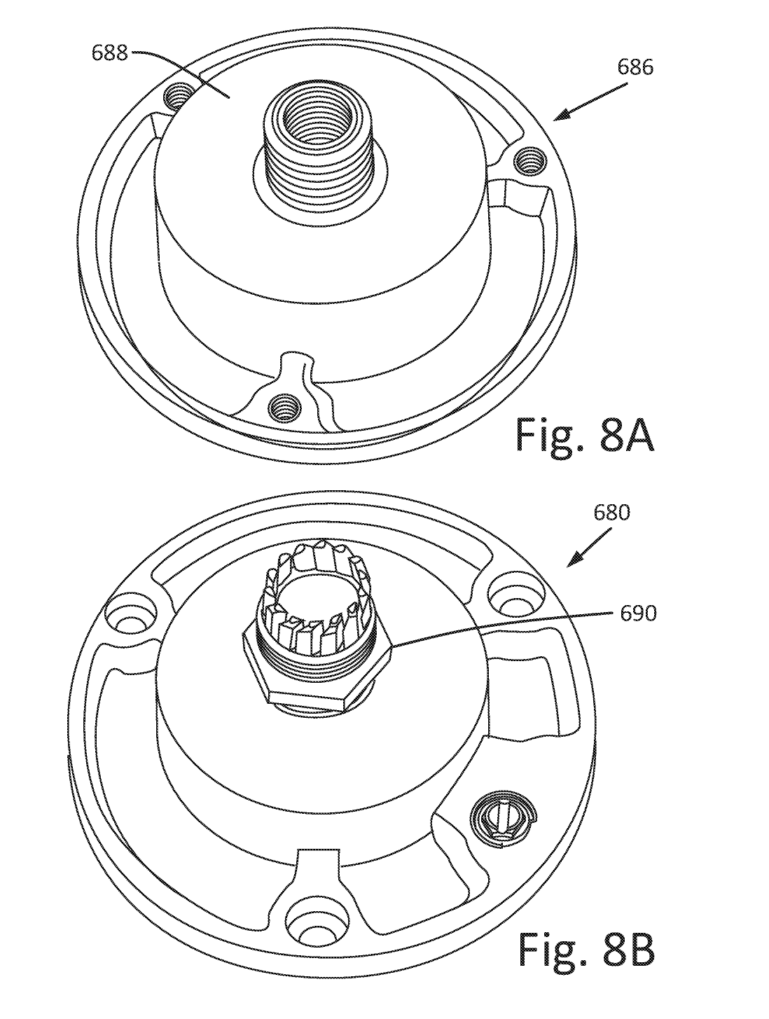

FIG. 8A is an elevation view of the housing 680 viewed from an opposite side. The cover 680 can have a threaded nipple 690 via which the housing can be connected to the fuel transfer pump 110. FIG. 8B is a drawing of the cover 686 viewed from an opposite side. As shown, the cover 686 can have an opening and a connection 690 for a power whip (i.e., cable) that connects to the pump electrical input and is stored in the pump cavity.

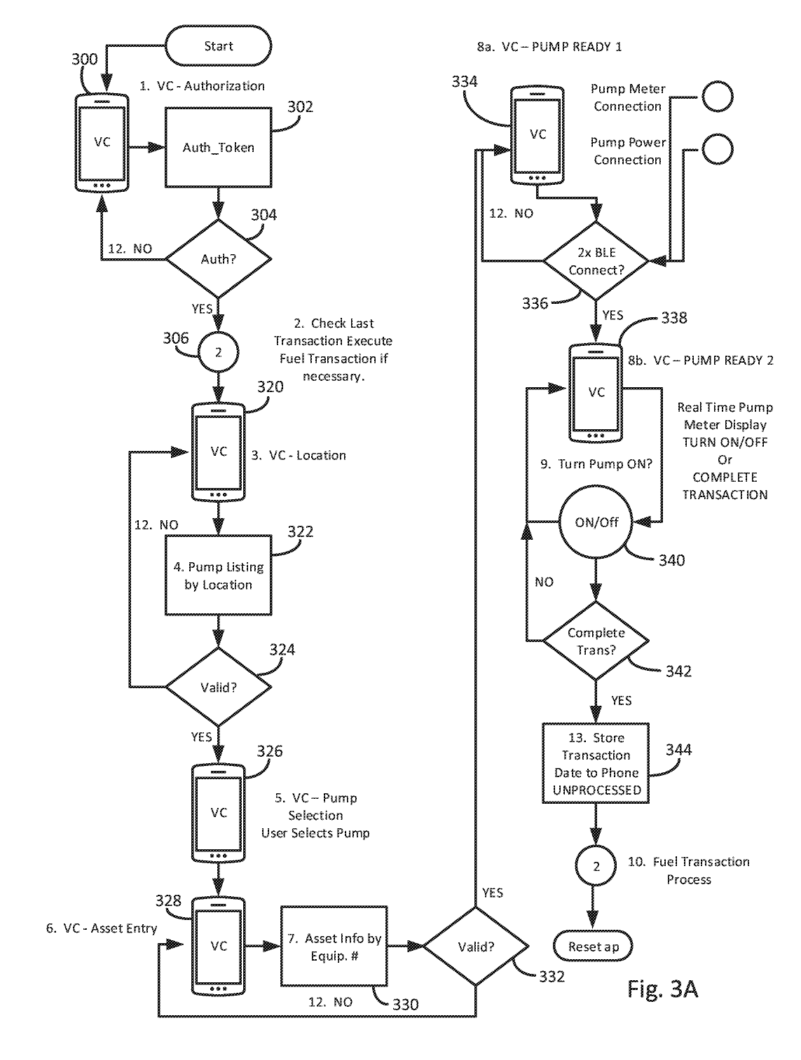

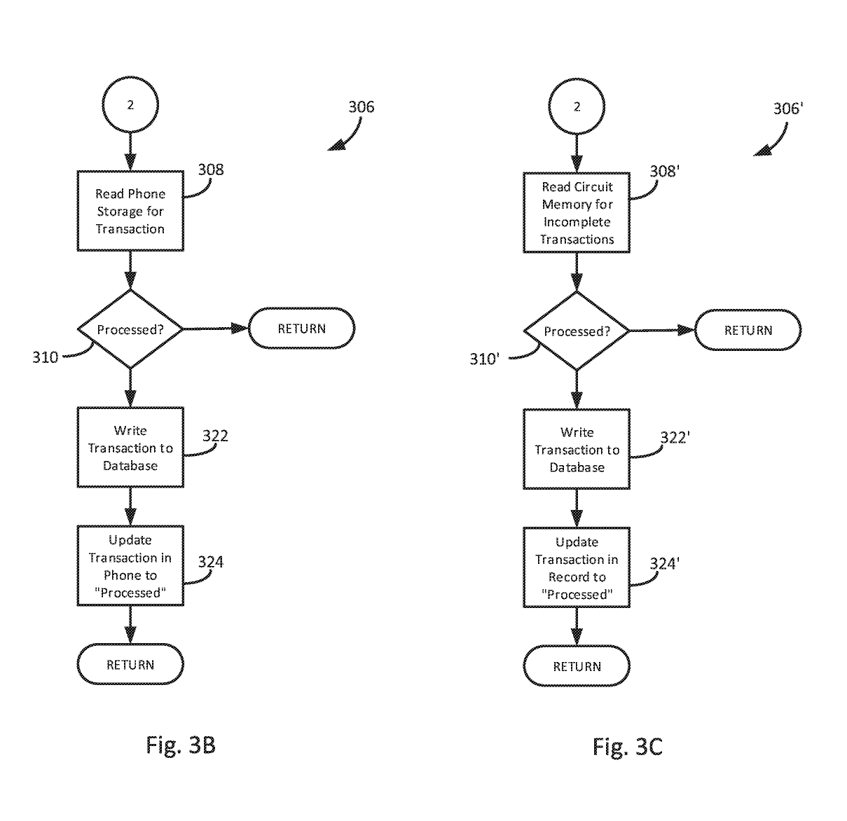

FIGS. 3A, 3B and 3C are flow diagrams illustrating operation of a software application on the mobile device 200, which is referred to as a view controller (VC), while it is running and being used to interact with the fuel transfer pump system 100. Following initialization of the VC by a user, in step 300 the VC prompts the user for authorization. The VC receives the user's response, which can be an entry via a touchscreen (or a voice command, a fingerprint scan or other similar type of user entry readily made with a mobile device) and/or a unique code or identification stored in the mobile device.

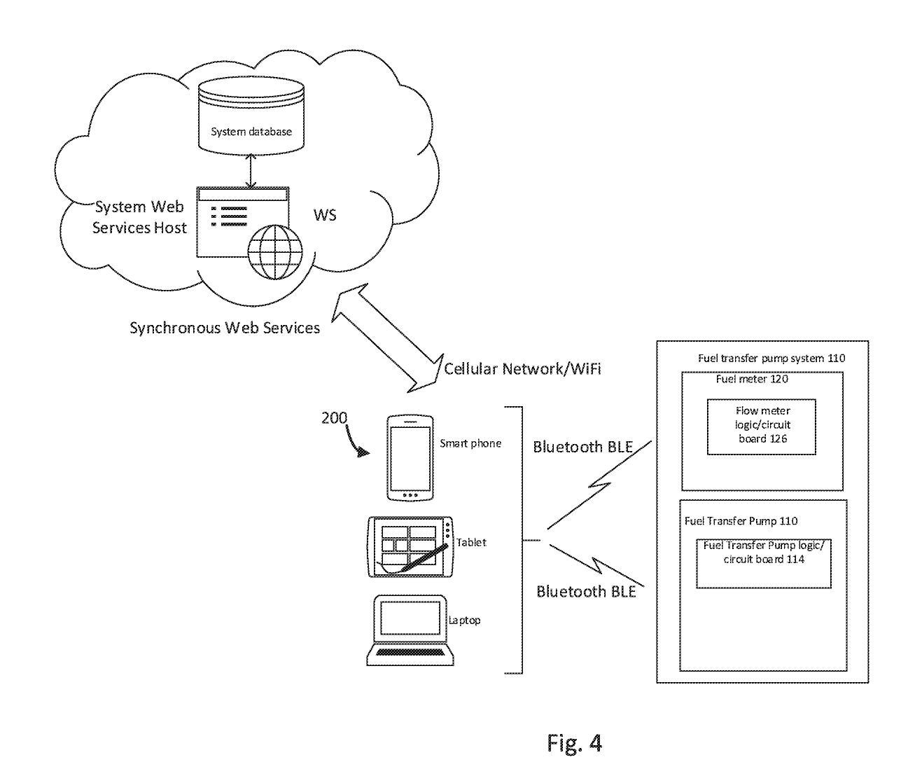

Two-factor authentication can be used, such as by authorizing a registered user according to the user's phone number, assigned authorization code and mobile device UUID. Following the user's communication with a synchronous web service (WS), e.g., as shown in FIG. 4, the WS determines whether the user's phone number is in a database and, if so, issues an authorization token. The WS updates the database and causes a text message to be sent to the mobile device with a deep link to the authorization token (step 302). One suitable deep link technology is the Apple iOS Universal Links deep link technique, but other standards can also be used. After the user responds via the mobile device, then the token, the phone number and the mobile device UUID are retransmitted to the WS for authentication against the updated database values (step 304). If the user is authorized, then the process proceeds to step 306. If the user is not determined to be authorized, then the process returns to step 300.

In the illustrated implementation, step 306 includes a subroutine that checks the last transaction completed by the mobile device and updates transaction records as necessary. Specifically, as shown in FIG. 3B, in step 308 the memory of the mobile device is read, such as by a synchronous web service (WS) with which the VC is wirelessly connected, or other similar link, to determine a most recent transaction. In step 310, it is determined whether the most recent transaction has already been processed, i.e., that a record of the transaction is in the system database. If so, then the process proceeds to step 320. If not, then in step 322 the VC writes the transaction to the system database. In step 324, the status of the most recent transaction in the mobile device memory is changed to “processed” to reflect that system database includes a record of the transaction.

In some implementations, there is a second step 306′, which can be carried out instead of or in addition to the step 306. Step 306′ includes a subroutine that checks if at least one previous transaction at the transfer pump is an incomplete transaction (i.e., one that was not successfully uploaded to the WS), without regard to whether the incomplete transaction(s) was by the same user/mobile device or by a different user(s)/different mobile device(s). This is another example of “condition handling” that can be enabled. In step 308′, the memory of the transfer pump circuit is read. In step 310′, it is determined whether there are any incomplete transactions that were not processed. If not, then the process proceeds to step 320. If there is at least one incomplete transaction, then in step 322′, the VC receives the incomplete transaction data and uploads it to the system database. This is preferably done without disclosing the data to the current user or storing it on his mobile device, since the incomplete transaction may relate to another user/another mobile device. In step 324, the status of the most recent transaction in the transfer pump circuit memory is changed to “processed” to reflect that system database includes a record of the transaction.

Returning to the main process, in step 320, the VC queries the user to enter his location. The user can enter his location, e.g., by way of reference to a geographic location, such as a particular pump location, or by coordinates, or by reference to a default location saved for the user, as just several examples. Alternatively, the current location of the mobile device can be determined automatically. During initialization of the application, the user can be prompted to allow location services to be used in connection with the application. If allowed, the application uses the mobile device's location services capabilities when triggered to determine a current location for use by the application.

In step 322, for the sake of explanation, it is assumed that the desired pump will be identified by the user, so the WS causes a listing of pumps to be displayed on the mobile device, such as, e.g., in order of proximity from the user's current location or another desired ordering. In step 324, the user's input to select one of the pumps is evaluated to determine if it is valid. If not, the process flow returns to step 320.

In step 326, the VC receives the user's selection of one of the pumps. In step 328, the VC displays the stored information for the selected pump. Such information can include Equipment Number, Category, Class, Make, Model, maximum amount of fuel that can be pumped, etc. In step 328, the VC then prompts the user to identify the asset, which may be a vehicle, equipment or another type of asset to which fuel is to be added.

In step 330, the WS returns stored information on the identified asset, including the type(s) of fuel suitable for the asset and its fuel capacity. In step 332, the WS validates the entered asset identification.

In step 334, the VC receives communication(s) that the selected pump and corresponding meter are wirelessly linked or connected to the mobile device. In the illustrated implementation, the pump and the corresponding meter each establish a separate communication with the VC. For example, the VC can receive a SWITCH UUID from the fuel transfer pump circuit 114, and a METER UUID from the fuel meter circuit 126. In the illustrated implementation, the fuel transfer pump circuit 114 is configured to broadcast a Bluetooth BLE advertising packet of data that includes the SSWITCH UUID (or other identifier corresponding to the pump). Similarly, the fuel meter circuit is configured to broadcast a Bluetooth BLE advertising packet of data that includes the METER UUID (or other identifier corresponding to the meter). In step 336, the VC determines whether the expected number of devices have been wirelessly connected. If not, then the process returns to step 334.

If the pump and the corresponding meter are successfully connected, then in step 338 the VC displays a “Pump Ready” or similar message. In step 340, the VC determines whether the user has turned the pump on, such as via a PUMP ON/OFF button displayed on the VC. If the user has turned the pump on and depressed the lever on the nozzle, then the VC will display a real-time gauge showing the amount of fuel that has been pumped. The user can turn the pump off by pressing the PUMP ON/OFF button again. If the VC determines that the transaction is complete in step 342, such as if the user has pressed a displayed COMPLETE TRANACTION button on the WC, then the process proceeds to step 344, and the transaction data is stored in the memory of the mobile device. The VC is then reset to display the list of fuel pumps, and a button is displayed that the user can press to log off the application.

In addition, the WS also stores the transaction data. For example, the transaction data may include the user information, location information, pump information, fuel type, asset identification amount of fuel, date, time and a system generated transaction identifier. If the upload of the transaction data from the VC to the WS is successful, then a message (e.g., “OK”) is displayed to the user. If the upload of the transaction data is not successful, then the system will attempt to upload it in step 306 as described above. In one implementation, any communication errors are logged on the server side.

In one implementation in which Bluetooth LE communications are used, an output set characteristic is used to control the fuel transfer pump 110. The instruction Output Set=1 will be sent to enable the pump, and the instruction Output Set=0 will be sent to disable it. For the fuel meter 120, both the output set characteristic and a FC Ticks characteristic are used. The instruction Output Set=1 will enable the pulser, and the VC will be subscribed to the FC Ticks characteristic so that whenever a predetermined number of pulses is read (from one to several pulses over a selected interval), the number of read pulses is sent to the VC so that it can be displayed on the mobile device. In addition, pump operation data that includes the current draw on the pump motor can be tracked and stored (such data can be used for several purposes, including troubleshooting and scheduling maintenance).

In the event that the communication link between the mobile device 200 and fuel transfer pump circuit 114 is interrupted, all outputs from the fuel transfer pump circuit 114 will be turned off. The controller 130A will send an instruction to cause operation of the fuel transfer pump 110 to cease immediately, the switch 132A will return to an open state, and the flow of fuel will be stopped. Similarly, in the event that the communication link between the mobile device 200 and the fuel meter circuit 126 is interrupted, all outputs from the fuel meter circuit 126 will be turned off. The pulser input 150B indicating operation of the flow meter 120 will be turned off and no longer read. The controller 130B will send an instruction to cause operation of the fuel meter 120 to cease immediately, and the switch 132B will return to an open state.

In the context of operating a fuel transfer pump, it is assumed that the user must physically actuate some component to initiate operation of the pump, and thus must be proximate the pump at least when it is initiated. In the one specific implementation, the user must insert a nozzle into the tank or container to be filled and squeeze a pump lever to cause fuel to flow. Instead of or in conjunction with such requirements dictating that a user must be physically proximate, the system can be programmed to allow operation only if a user is within a predetermined range, i.e., only if a user remains within Bluetooth operation range, as one example. In the described example, if the Bluetooth link with the pump or the meter is interrupted, then the associated device is shut off. The user must re-start the transaction, including re-establishing the Bluetooth links.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A fuel transfer pump electrical circuit for controlling a fuel transfer pump, comprising:
a controller with communications logic configured for establishing a wireless communications link with a mobile device; and
a switch for activating a motor in the pump, the switch being controllably linked to the controller;
wherein the controller is configured to turn the switch on and off based on instructions received via the wireless communications link.

2. The fuel transfer pump electrical circuit of claim 1, further comprising a flow meter control logic connectible to a flow meter associated with the fuel transfer pump, wherein the flow meter control logic comprises communications logic configured for establishing a separate flow meter wireless communications link with the mobile device via which flow data from the flow meter can be transmitted to mobile device.

3. The fuel transfer pump electrical circuit of claim 1, further comprising a flow meter output from a flow meter associated with the fuel transfer pump, wherein the flow meter output is linked to the controller and used in controlling the fuel transfer pump.

4. The fuel transfer pump electrical circuit of claim 1, wherein the controller is configured to receive an output set characteristic communicated from the mobile device via the wireless communications link and, in response, to control the switch to turn the fuel transfer pump on and off.

5. The fuel transfer pump electrical circuit of claim 3, wherein the flow meter output comprises a pulser output configured to transmit pulse counts indicating operation of the flow meter.

6. A control circuit for a fuel transfer pump, comprising:
a circuit board configured for installation in a recess of a housing, the circuit board comprising:
a controller with communications logic configured for establishing a wireless communications link with a mobile device;
a fuel transfer pump switch for activating a motor in the pump, the switch being controllably linked to the controller; and
a pulser input linked to the controller and configured to receive pulse counts indicating operation of a flow meter associated with the fuel transfer pump.

7. The control circuit of claim 6, wherein the fuel transfer pump comprises the housing for the circuit board.

8. The control circuit of claim 6, wherein the housing comprises a separate housing configured to be coupled to the fuel transfer pump.

9. The control circuit of claim 8, wherein the housing comprises an explosion-proof housing.

10. The control circuit of claim 6, wherein the circuit board comprises at least one of an accelerometer and an altimeter.

11. The control circuit of claim 6, wherein the wireless communications link is established according to a Bluetooth low energy protocol.

12. The control circuit of claim 6, wherein the circuit board comprises a memory for storing fuel transfer pump operation data, and wherein the fuel transfer pump controller causes fuel transfer pump data for a most recent transaction to be uploaded to the mobile device for communication to a web service upon restoration of the wireless communications link following an interruption.

13. The control circuit of claim 6, wherein the circuit board comprises a memory for storing fuel transfer pump operation data, and wherein the fuel transfer pump controller causes fuel transfer pump data for at least one prior incomplete transaction to be uploaded to the mobile device for communication to a web service upon establishment of a new wireless communications link for a next transaction following the incomplete transaction.

14. A software application for configuring a mobile device to control a fuel transfer pump system, comprising:
instructions for establishing a wireless communications link between the mobile device and a circuit of the fuel transfer pump;
instructions for establishing a wireless communications link between the mobile device and a web service;
instructions for carrying out two-factor authentication of the mobile device through queries displayed to the user on the mobile device and communications of data to the web service to determine if the mobile device is authorized;
if the mobile device is authorized, instructions for displaying fuel transfer pump operation commands on the mobile device, receiving user input via the mobile device corresponding to a selected command and communicating the command to the fuel transfer pump circuit.

15. The software application of claim 14, further comprising instructions to cause transaction data stored in a memory of a fuel transfer pump circuit connected to the fuel transfer pump to be communicated from the fuel transfer pump circuit to the mobile device and from the mobile device to the web service.

16. The software application of claim 15, wherein the instructions to cause data from the fuel transfer pump to be communicated to the mobile device are issued following completion of a fuel transfer pump pumping event.

17. The software application of claim 15, wherein the instructions to cause data from the fuel transfer pump to be communicated to the mobile device are issued following resumption of a wireless communication link between the mobile device and the fuel transfer pump following an interruption.

18. The software application of claim 15, wherein the instructions to cause data from the fuel transfer pump to be communicated to the mobile device are issued following establishment of a new wireless communication link between a new mobile device and the fuel transfer pump following an incomplete transaction, and wherein the data communicated comprises data for at least one prior incomplete transaction.

19. The software application of claim 14, further comprising instructions for transmitting flow meter data received by the fuel transfer pump system to the web service.

20. The software application of claim 14, further comprising instructions for transmitting flow transfer pump data from the fuel transfer pump system to the web service.

21. The software application of claim 14, further comprising instructions for querying a user for a selected location, receiving an input from the mobile device indicating a selected location and displaying fuel transfer pump locations corresponding to the selected location.

22. The software application of claim 14, further comprising instructions for querying a user for a selected asset to be fueled, receiving an input from the mobile device indicating the selected asset and displaying asset information for the selected asset to the user.
